(19) United States
(12) Patent Application Publication
(10) Pub. No.: US 2026/0219457 A1
(43) Pub. Date: Jul. 30, 2026

(54) A SYSTEM FOR DIRECTING INCIDENT LIGHT ONTO SPATIAL LIGHT MODULATOR PLANES

(71) Applicant: HUBER+SUHNER POLATIS LIMITED, Cambridge (GB)

(72) Inventors: David James MONTGOMERY, Cambridge (GB); Peter John WILKINSON, Cambridge (GB)

(73) Assignee: HUBER+SUHNER POLATIS LIMITED, Cambridge (GB)

(21) Appl. No.: 19/141,412

(22) PCT Filed: Dec. 8, 2023
(86) PCT No.: PCT/GB2023/053172

§ 371 Date: Jun. 20, 2025

(30) Foreign Application Priority Data
Dec. 21, 2022 (GB) 2219364.3
Jan. 20, 2023 (GB) 2300913.7

(51) Int. Cl. G02B 6/35; G02B 6/27; G02F 1/31

(52) U.S. Cl. CPC G02B 6/3556; G02B 6/276; G02B 6/356; G02B 6/3594; G02F 1/31; G02F 2203/12

(57) ABSTRACT

An optical system comprising a first spatial light modulator plane having a first optically active area configured to receive a first optical signal from the optical system, and a second spatial light modulator plane having a second optically active area configured to receive a second optical signal from the optical system. The optical system also comprises a first reflector overlaying the first optically active area at an angle to the first optically active area so as to direct the first optical signal approaching the first reflector from a first direction onto the first optically active area; and a second reflector overlaying the second optically active area at an angle to the second optically active area so as to direct the second optical signal approaching the second reflector from a second direction onto the second optically active area, wherein the second direction is different to the first direction.

### BACKGROUND

Optical switches are used in optical telecommunication systems to route optical signals through networks. As optical telecommunications systems have become more popular, the quantity of data carried through the networks has increased, putting greater capacity demands on the switches. It is known to use wavelength division multiplexed (WDM) signals to enable each optical fibre in the network to carry multiple data channels, those data channels separated by unique central frequencies and having non-overlapping bandwidths. Wavelength selective switches (WSSs) are used to route WDM signals through the network. FIG. 1 illustrates schematically a known M×N WSS 100. The M×N switch comprises N input ports 101 and M output ports 102. Each port carries multiple data channels. A bank of 1×M WSSs 103 splits the multiplexed signal from each input port into its separate frequency channels. The demultiplexed data channels are then directed to the M output ports. A bank of N×1 WSSs 104 at the output combines the data channels into a set of multiplexed signals for output via the output ports 102. In this way, the M×N switch is able to redirect any data channel from an input port to any data channel in an output port, subject to the condition that two channels with overlapping frequencies are not routed to the same output port.

FIG. 2 illustrates schematically a known switch referred to as an add-drop WSS 200. Add-drop WSS 200 is a special type of WSS in which N input ports 201 are connected to K output ports 202, where K>N. A bank of 1×K WSSs 203 splits the multiplexed signal from each input port into its separate frequency channels. The demultiplexed data channels are then directed to K space switches 204. Each space switch 204 can accept data from any of the 1×K WSSs but can only output data from one of the input ports at a time. The output of each space switch 204 is then output from an output port 202, otherwise known as a drop port. Space switches are simpler to implement that N×1 switches, and hence the add-drop WSS of FIG. 2 is preferable to the M×N WSS of FIG. 1. This is particularly the case when K is much bigger than N, and the data density in the K output ports is much lower than in the N input ports.

Both the WSSs of FIGS. 1 and 2 are reversible. For example, edge reconfigurable optical add-drop multiplexers (ROADM) are used for transferring optical data between core dense wavelength divisional multiplexing (DWDM) and more coarse wavelength division multiplexing (CWDM). An add-drop WSS of the type in FIG. 2 is used in the “dropping” direction shown in FIG. 2 to transfer from DWDM to CWDM, and in the reverse “adding” direction (from K drop input ports to N output ports) to transfer from CWDM to DWDM.

Edge ROADMs and related adWSS and M×N switches are often made up of 1×N switches, typically multiple 1×N switches in a single module. FIG. 3 illustrates a 1×N switch 300. It has a single input port 301. A 1×N WSS 303 splits the multiplexed signal from the input port into its separate frequency channels. The demultiplexed data channels are directed to N output ports 302. A quad 1×N switch can be used to make a 4×4 optical switch or a 4 degree ROADM. A dual 1×N switch can be used to make an adWSS switch.

The switches shown in FIGS. 1, 2 and 3 are typically implemented by electronic conversion, for example by absorbing light and emitting it again in the desired format. However, electronic conversion has high power requirements and introduces a significant lag in the transmission through the switch. Purely optical methods are preferred because they require much less power than electronic implementations and also enable faster transmission.

Optical switches typically utilise spatial light modulators (SLMs) to direct data channels from the input port to the desired output port. 1×N WSSs using free space SLM devices are known, as are the use of multiple 1×N switches on a single SLM device. Two plane architectures for M×N and add-drop WSS systems also exist.

These SLMs are typically implemented by a liquid crystal on silicon (LCOS) device or an optical microelectromechanical system (MEMS). These use an active element, such as LCOS or a MEMS mirror to impart a controllable angular deflection on the incident light. Typically, this light has previously been dispersed at a diffraction grating, and is subsequently re-multiplexed and sent to the output fibres in accordance with the optical deflection applied by the SLM. As shown in FIG. 4, the SLM plane is generally considered to be a vertical flat plane in conceptual space. This plane is normal to the optical axis, such that the light signal is incident on the plane in a direction normal to the plane. No optics are required to direct the light signal onto the SLM plane, however the SLM plane only accepts light normally from one direction. In practice, mounting and aligning an SLM plane vertically within the switch is problematic, since fine adjustments to the alignment of the light beams requires movement of the whole SLM assembly. This arrangement also makes heat sinking more problematic.

FIG. 5 illustrates a preferable arrangement, in which the SLM plane 501 is laid flat on the base of the switch parallel to the optical plane. A mirror or reflecting prism 502 placed at 45° to the optical axis is used to deflect the light signal down onto the SLM plane. Adjustment of the mirror or reflecting prism can be used to align the angle of incidence of the light beams on the SLM without moving the SLM. As with FIG. 4, the SLM plane only accepts light normally from one direction. The lower part of FIG. 5 depicts the SLM from above. The arrow shows the direction of reflection on the prism from the SLM. U.S. Pat. Nos. 7,092,599, 8,705,960 and 9,575,259 all describe use of the arrangement of FIG. 5.

U.S. Pat. Nos. 9,304,257 and 9,575,260 both describe utilising two reflecting surfaces at an LCOS panel. Light is incident from a single direction onto the LCOS panel. The system encodes the C and L bands of the spectrum with orthogonal polarisations. The two reflecting surfaces are used to separate the C and L bands by virtue of those reflecting surfaces reflecting orthogonal polarisations. This causes the C and L bands to be placed vertically with respect to each other on the LCOS instead of linearly, which better utilises space on the LCOS and improves passband performance.

### SUMMARY OF THE INVENTION

According to an aspect of the invention, there is provided an optical system comprising: a first spatial light modulator plane having a first optically active area configured to receive a first optical signal from the optical system; a second spatial light modulator plane having a second optically active area configured to receive a second optical signal from the optical system; a first reflector overlaying the first optically active area at an angle to the first optically active area so as to direct the first optical signal approaching the first reflector from a first direction onto the first optically active area; and a second reflector overlaying the second optically active area at an angle to the second optically active area so as to direct the second optical signal approaching the second reflector from a second direction onto the second optically active area, wherein the second direction is different to the first direction.

The first optically active area may be coplanar with the second optically active area.

The first and second spatial light modulator planes may be parallel to the optical axis plane of the optical system.

A single spatial light modulator device may comprise the first and second spatial light modulator planes.

The incidence normal of the first spatial light modulator plane may be within the same hemispherical angular area as the incidence normal of the second spatial light modulator plane.

The first reflector may comprise a 45° reflecting surface configured to turn the first optical signal incident on it by 90° so as to direct the first optical signal normal to the plane of the first optically active area; and the second reflector may comprise a 45° reflecting surface configured to turn the second optical signal incident on it by 90° so as to direct the second optical signal normal to the plane of the second optically active area.

The centre of the reflecting area of the first reflector, the centre of the reflecting area of the second reflector, and the optical axis of the optical system may all be in the same plane.

The first direction may oppose the second direction.

The first direction may be perpendicular to the second direction.

The first reflector and/or second reflector may be mirrors.

The first reflector and/or second reflector may be prisms.

The first reflector and/or second reflector may be diffractive reflectors or holograms.

The first reflector and/or second reflectors may be beam splitters.

The first reflector and/or second reflector may comprise a half wave plate.

The first optically active area may be a programmable deflection plane.

The second optically active area may be a programmable deflection plane.

The second optically active area may be a programmable attenuation plane.

The first reflector may overlay the first optically active area at an angle to the first optically active area so as to direct the first optical signal normal to the plane of the first optically active area.

The second reflector may overlay the second optically active area at an angle to the second optically active area so as to direct the second optical signal normal to the plane of the second optically active area.

The first optical signal may be the same as the second optical signal.

The optical system may be an optical switch comprising: a set of input ports, each input port configured to transport the first optical signal having at least one component frequency channel; a set of output ports, each output port configured to transport the second optical signal having at least one component frequency channel; and beam steering optics configured to direct the first optical signal in the first direction to the first reflector, and configured to direct the second optical signal in the second direction to the second reflector.

The optical system may further comprise: a third spatial light modulator plane having a third optically active area configured to receive a third optical signal from the optical system; and a third reflector overlaying the third optically active area at an angle to the third optically active area so as to direct the third optical signal approaching the third reflector from a third direction onto the third optically active area. The first, second and third directions may all be different. The first and third directions may be the same.

The third optically active area may be a programmable deflection plane.

### BRIEF DESCRIPTION OF THE FIGURES

The present invention will now be described by way of example with reference to the accompanying drawings. In the drawings:

FIG. 1 illustrates a known M×N WSS;

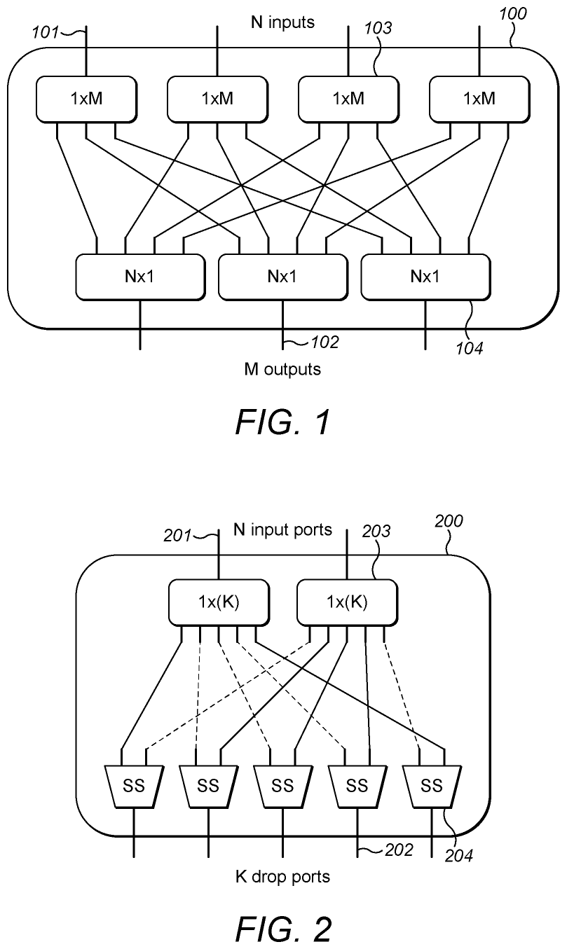

FIG. 2 illustrates a known add-drop WSS;

FIG. 3 illustrates a known 1×N WSS;

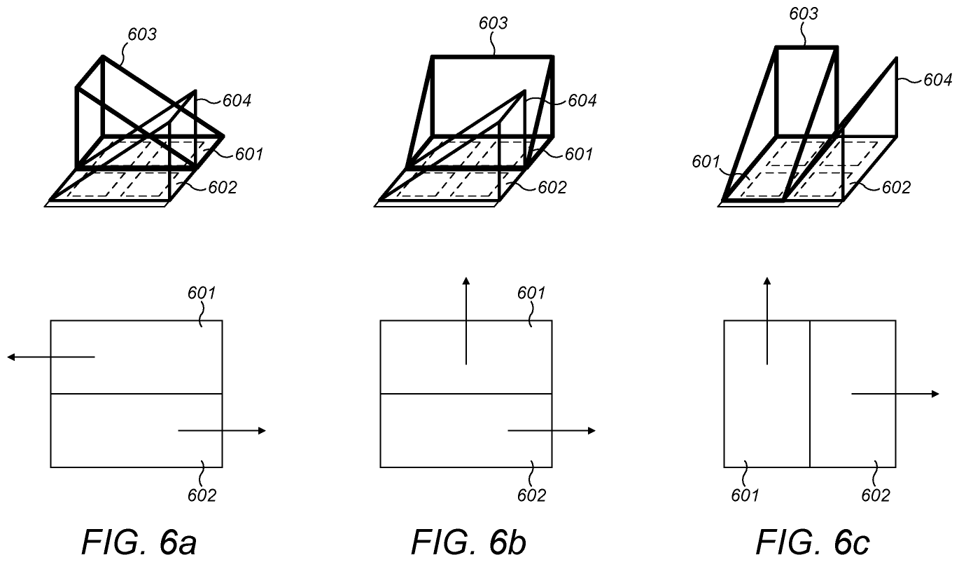

FIG. 4 illustrates a known SLM placed vertically in a switch;

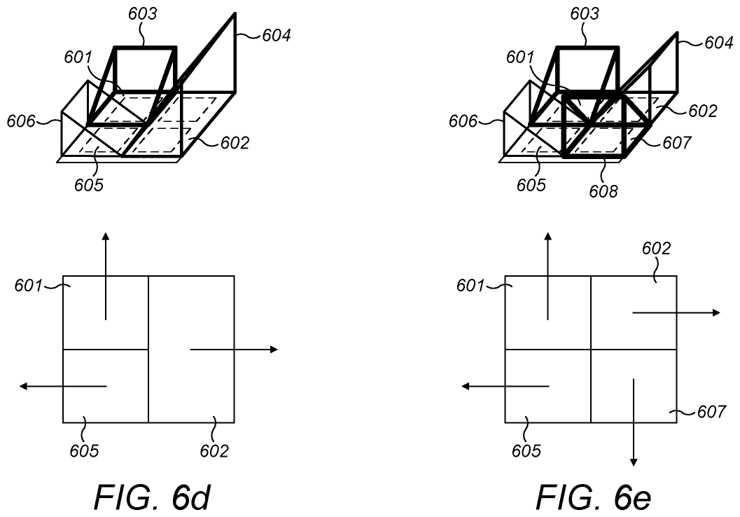

FIG. 5 illustrates a known SLM placed horizontally in a switch with a prism reflecting the light signal down onto the SLM;

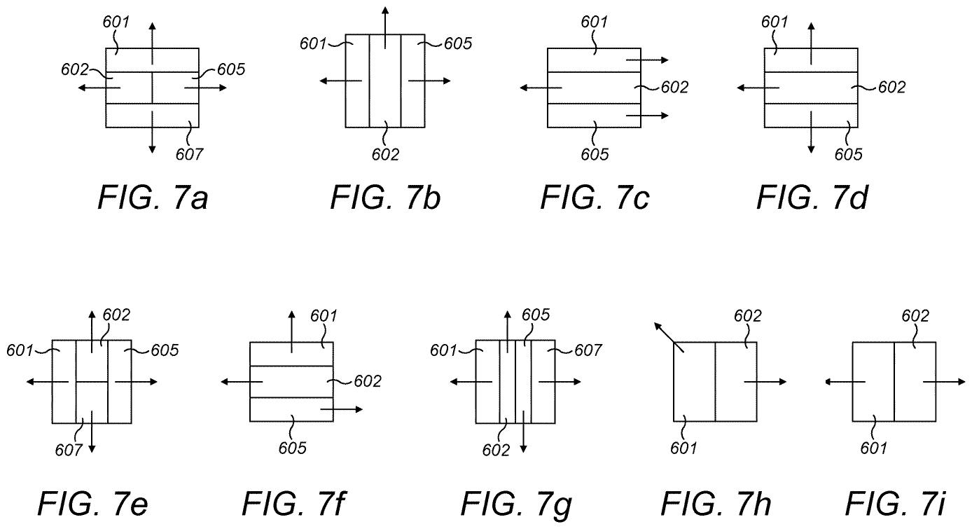

FIGS. 6a to 6e illustrate optical arrangements of SLM planes and reflecting surfaces;

FIGS. 7a to 7h illustrates further optical arrangements of SLM planes and reflecting surfaces;

FIGS. 8a and 8b illustrate further optical arrangements of vertical SLM planes and reflecting surfaces;

FIG. 9 illustrates an optical arrangement having different sized optically active areas and reflectors;

FIG. 10 illustrates a two-plane WSS utilising the optical arrangement shown in FIG. 6a;

FIGS. 11a and 11b illustrate the optical path of the WSS of FIG. 10 in the switching plane and dispersion plane respectively;

FIG. 12 illustrates a two-plane WSS utilising the optical arrangement shown in FIG. 6a;

FIGS. 13a and 13b illustrate the optical path of the WSS of FIG. 12 in the switching plane and dispersion plane respectively;

FIG. 14 illustrates the polarising beam splitter of FIG. 12;

FIG. 15 illustrates an optical switch in a 1×N system; and

FIG. 16 illustrates an implementation of the gap optic of FIGS. 10 and 12.

### DETAILED DESCRIPTION

The following describes several exemplary optical systems which utilise two SLM planes, each overlaid with a reflector for directing an optical signal onto the SLM plane. The optical signals approach the reflectors from different directions, thereby enabling a compact layout for the optical system.

The described optical systems may be WSSs. In particular, the optical systems may be a one-plane 1×N switch. Alternatively, the optical system may be a multi 1×N WSS, which consists of multiple independent 1×N WSSs in the same package. Or the optical system may be a two-plane M×N WSS or a two-plane add-drop WSS. The described optical systems may be used as the basis for constructing a ROADM or another architecture for transferring light from core DWDM networks to lower capacity CWDM networks or vice versa. In all the described examples, at least two optically active areas on SLM planes are used to route the optical signals through the system.

All the examples described herein use optical components to route light through the optical system. There is no absorption and re-emission of light.

Several exemplary optical arrangements of SLM planes and reflecting surfaces will be described first, followed by some example optical switches into which these optical arrangements may be incorporated.

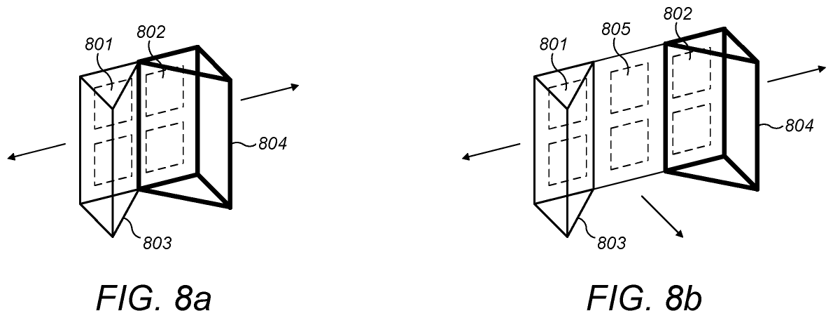

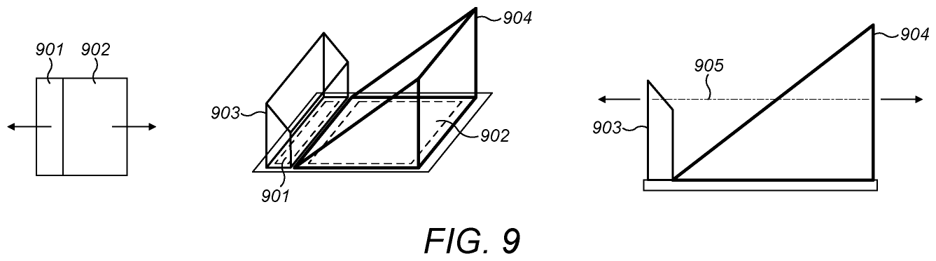

FIGS. 6 and 7 illustrate several optical arrangements, each of which comprises two or more optically active areas of one or more SLM planes. A reflector overlays each optically active area. In each arrangement, at least two of the reflecting surfaces are arranged at different angles relative to their respective optically active areas, such that they direct optical signals approaching from different directions onto their respective optically active areas.

The top part of each example of FIG. 6 illustrates the optical arrangement from an oblique angle, and the bottom part of each example illustrates the optical arrangement from above. FIG. 6a illustrates an SLM having two optically active areas 601 and 602. The optically active areas 601 and 602 are the same size. The SLM is bisected into two halves: one half being the optically active area 601 and the other half being the optically active area 602. Both optically active areas 601 and 602 are rectangular in shape. A first reflector 603 overlays the first optically active area 601. The first reflector 603 overlays the whole of the optically active area 601. A second reflector 604 overlays the second optically active area 602. The second reflector 604 overlays the whole of the optically active area 602. Each of the reflectors comprises a reflecting surface arranged at 45° to the optical axis and at 45° to the plane of the optically active area. Each reflector thereby causes an optical signal incident on it in the plane of the optical axis to be deflected by 90° so as to be incident on the optically active area normal to the plane of the optically active area. The reflectors 603 and 604 are in a V-shaped arrangement. The reflectors 603 and 604 oppose each other. The arrows in FIG. 6 illustrate the direction of reflection of the optical signal leaving the reflectors after interacting with the optically active area of the SLM plane. In FIG. 6a, those arrows are in opposite directions. Thus, optical signals incident on the two reflectors 603 and 604 from opposing directions are deflected by 90°by the reflectors 603 and 604 onto the optically active areas 601 and 602, are output from the optically active areas back onto the reflectors 603 and 604, where they are deflected by 90° so as to leave the optical arrangement of FIG. 6a in opposing directions.

FIG. 6b illustrates an exemplary SLM having two optically active areas 601 and 602. The SLM arrangement is the same as that shown in FIG. 6a. FIG. 6b differs from FIG. 6a in that the reflectors 603 and 604 are arranged perpendicularly with respect to each other. Thus, optical signals incident on the two reflectors 603 and 604 from perpendicular directions in the plane of the optical axis are deflected by 90° by the reflectors 603 and 604 onto the optically active areas 601 and 602, are output from the optically active areas back onto the reflectors 603 and 604, where they are deflected by 90° so as to leave the optical arrangement of FIG. 6b in perpendicular directions in the plane of the optical axis, as shown by the arrows in FIG. 6b.

FIG. 6c illustrates an exemplary SLM having two optically active areas 601 and 602. As with FIG. 6a, the SLM is bisected into two halves: one half being the optically active area 601 and the other half being the optically active area 602. The two optically active areas 601 and 602 are rectangular. The SLM of FIG. 6c differs from that of FIG. 6a in that the two optically active areas 601 and 602 are arranged perpendicularly to the arrangement in FIG. 6a. The reflectors 603 and 604 are arranged in the same orientation as described with respect to FIG. 6b and hence cause optical signals incident on the reflectors from the same directions described with respect to FIG. 6b to be deflected onto the optically active areas 601 and 602 in the same way and to leave the optical arrangement of FIG. 6c in the same directions. Thus, optical signals incident on the two reflectors 603 and 604 from perpendicular directions in the plane of the optical axis are deflected by 90° by the reflectors 603 and 604 onto the optically active areas 601 and 602, are output from the optically active areas back onto the reflectors 603 and 604, where they are deflected by 90° so as to leave the optical arrangement of FIG. 6c in perpendicular directions in the plane of the optical axis, as shown by the arrows in FIG. 6c.

FIG. 6d illustrates an exemplary SLM having three optically active areas 601, 602 and 605. The SLM is bisected, one half of which is the optically active area 602. The remaining half of the SLM is bisected again, forming two quadrants which are the optically active areas 601 and 605. A first reflector 603 overlays the first optically active area 601. A second reflector 604 overlays the second optically active area 602. A third reflector 606 overlays the third optically active area 605. The reflectors 603, 604 and 606 are arranged such that three optical signals incident on the three reflectors from three different directions in the plane of the optical axis are all deflected onto the optically active areas at angles normal to the plane of the optically active areas. The three optical signals consequently leave the optical arrangement in three different directions. Those different directions are all orthogonal, as shown by the arrows in FIG. 6d.

FIG. 6e illustrates an exemplary SLM having four optically active areas 601, 602, 605 and 607. The SLM is split into four equal quadrants, each quadrant being one of the optically active areas. A first reflector 603 overlays the first optically active area 601. A second reflector 604 overlays the second optically active area 602. A third reflector 606 overlays the third optically active area 605. A fourth reflector 608 overlays the fourth optically active area 607. The reflectors 603, 604, 606 and 608 are arranged such that four optical signals incident on the four reflectors from four different directions in the plane of the optical axis are all deflected onto the optically active areas at angles normal to the plane of the optically active areas. The four optical signals consequently leave the optical arrangement in four different directions. Those different directions are all orthogonal, as shown by the arrows in FIG. 6e.

The optical arrangements of FIG. 7 are shown from above, not explicitly showing the reflecting surfaces.

FIGS. 7a, 7e and 7g illustrate exemplary SLMs having four optically active areas 601, 602, 605 and 607. The four optically active areas have different shapes and sizes. The reflectors are arranged such that four optical signals incident on the four reflectors from four different directions in the plane of the optical axis are all deflected onto the optically active areas at angles normal to the plane of the optically active areas. The four optical signals consequently leave the optical arrangement in four different directions. Those different directions are all orthogonal, as shown by the arrows in FIGS. 7a, 7e and 7g.

FIGS. 7b, 7c, 7d and 7f illustrate exemplary SLMs having three optically active areas 601, 602 and 605. Each SLM is split into three equally sized and shaped rectangular optically active areas which abut each other. In FIGS. 7b, 7d and 7f, the reflectors are arranged such that three optical signals incident on the three reflectors from three different directions in the plane of the optical axis are deflected onto the optically active areas at angles normal to the plane of the optically active areas. The three optical signals consequently leave the optical arrangement in three different directions. Those different directions are all orthogonal, as shown by the arrows in FIGS. 7b, 7d and 7f. In FIG. 7c, the reflectors are arranged such that two of the optical signals are incident on two of the reflectors in the same direction, and the third optical signal is incident on the remaining reflector in the opposite direction. All of the optical signals are deflected by the reflectors onto the optically active areas at angles normal to the plane of the optically active areas. The three optical signals consequently leave the optical arrangement with two of the signals in the same direction, and the third signal in a direction opposing the first two.

FIG. 7h illustrates an exemplary SLM having two optically active areas 601 and 602. The two optically active areas are as described with respect to FIG. 6c. In FIG. 7h, the reflectors are arranged such that optical signals incident on the reflectors from different directions which are within the plane of the optical axis but non-parallel and non-orthogonal are deflected onto the optically active areas at angles normal to the plane of the optically active areas. The two optical signals consequently leave the optical arrangement in non-parallel and non-orthogonal directions in the plane of the optical axis. In FIG. 7h, one of the optical signals follows a path that is parallel to one of the sides of the SLM, whilst the other optical signals follows a path that is neither parallel nor orthogonal to any of the sides of the SLM.

FIG. 7i illustrates an exemplary SLM having two optically active areas 601 and 602. The two optically active areas are as described with respect to FIG. 6c. In FIG. 7i, the reflectors are arranged such that optical signals incident on the reflectors from opposing directions orthogonal to the edge of the SLM and orthogonal to the line bisecting the SLM into the two optically active areas are deflected onto the optically active areas at angles normal to the plane of the optically active areas. The two optical signals consequently leave the optical arrangement in opposing directions.

In the examples described with respect to FIGS. 6 and 7, the optically active areas are located on the same planar SLM device. The optically active areas shown are thus coplanar. However, the optically active areas may be on separate SLM devices. Those SLM devices may be parallel. Those SLM devices may be coplanar.

Although in the examples described with respect to FIGS. 6 and 7, the optically active areas are coplanar, then may instead be at an angle to each other. In this case, the incidence normal of the plane of the first optically active area is within the same hemispherical angular area as the incidence normal of the plane of the second optically active area. Thus, the first SLM plane having the first optically active area may be at an angle to the second SLM plane having the second optically active area as long as the incidence normal of the first SLM plane is within the same hemispherical angular area as the incidence normal of the second SLM plane.

The optically active areas may be parallel to the optical axis plane of the optical signals incident on the described optical arrangements. Alternatively, the optically active areas may be non-parallel to the optical axis plane of the optical signals incident on the described optical arrangements. In this case, one or more additional optical elements, such as mirrors and/or prisms, may be implemented in the optical path prior to the reflector to deflect the incident optical signals onto the reflector at an angle parallel to the plane of the optically active area. Alternatively, the reflectors may comprise a reflecting surface arranged at an angle different to 45° to the optical axis and 45° to the plane of the optically active area. The angle of the reflecting surface with respect to the optical axis and/or the optically active area may be chosen so as to cause the optical signal to be deflected onto the optically active area at an angle normal to the plane of the optically active area. Alternatively, one or more of the optically active areas may be such that they are able to act effectively on light incident from a non-normal direction. In this case, if the optically active area is non-parallel to the optical axis plane, a reflecting surface of 45° to only one of the optical axis and plane of the optically active area may be implemented resulting in an optical signal incident on the optically active area which is not at 90° to the plane of the optically active area.

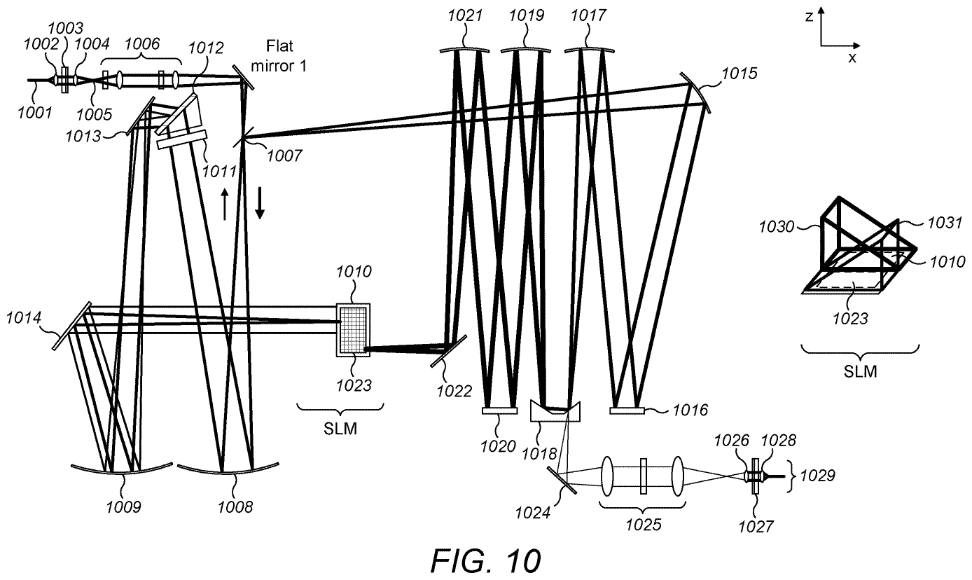

The optically active areas may be perpendicular to the plane of the optical axis. FIGS. 8a and 8b illustrate two such arrangements. FIG. 8a has two optically active areas 801 and 802 on an SLM device, each overlaid with a reflector 803, 804. The optically active areas 801 and 802 are located on a single planar SLM device which is arranged vertically, perpendicular to the plane of the optical axis. The centres of the reflectors 803 and 804 are in the plane of the optical axis. As described above, each reflector 803, 804 comprises a 45° reflecting surface which deflects the optical signal incident on it by 90° so as to fall incident on the optically active area at an angle normal to the plane of the optically active area. The optical signals incident on reflectors 803 and 804 are from opposing directions.

FIG. 8b illustrates an arrangement which is the same as FIG. 8a, except that it comprises an additional optically active area 805 between optically active areas 801 and 802. The optically active areas 801, 802 and 805 are all located on a single planar SLM device. There is no reflector overlaying the third optically active area 805. Three optical signals are incident on the arrangement of FIG. 8b from three different directions. The optical signals incident on reflectors 803 and 804 are deflected by 90° to fall incident on optically active areas 801 an 802 at an angle normal to the plane of optically active areas 801 and 802. The optical signal incident on optically active area 805 is normal to optically active area 805. Thus, the optical signal incident on optically active area 805 is orthogonal to the opposing optical signals incident on reflectors 803 and 804.

Two, three and four optically active areas per optical arrangement have been described in the above optical arrangements. However, the optical arrangement may comprise any number of optically active areas. Any number of those optically active areas may be overlaid with a reflector as described above.

The SLM planes and optically active areas depicted in FIGS. 6 and 7 are square or rectangular in shape. However, each SLM plane and/or each optically active area may have any shape. For example, hexagonal, triangular, circular or trapezoidal shaped SLMs may be used. The different optically active areas of an optical arrangement may be the same size, or differently sized. For example, in FIGS. 6a to 6c, 7h and 7i, the two optically active areas may have the same height as each other but different widths. The different optically active areas of an optical arrangement may abut each other, or may be spaced apart. Spacing the optically active areas apart allows for the divergence of a beam where the beam waist is larger at the mirror than that focused on the SLM. More than one optically active area of an optical arrangement having three or more optically active areas may have the same reflector direction. The reflector directions may be parallel to the SLM side, or may be non-parallel to the SLM side. The reflector directions may be at any angle with respect to each other.

The reflectors of an optical arrangement as described above may be implemented by any one or combination of the following:
A mirror, which may be a half-silvered mirror;
A prism. The reflection may be by mirror reflection or by total internal reflection;
A diffractive reflector or hologram.
A beam splitter. The beam splitter may be polarising or non-polarising.
A freeform optical element.

Each reflector may comprise a half wave plate to alter the polarisation of the optical signal.

The optically active areas may be programmable deflection planes. A programmable deflection plane applies a programmable deflection to an incident optical signal. For an incident demultiplexed optical signal which forms a spectrum on the programmable deflection plane, each beam of the dispersed array of beams is deflected by the programmable deflection plane individually to form a deflected array of beams. For an incident multiplexed optical signal which forms a space switch on the programmable deflection plane, the multiplexed optical signal is deflected by the programmable deflection plane to form a deflected optical signal. The deflection applied by a programmable deflection plane is reconfigurable. Thus, a controller providing a control signal to the programmable deflection plane may change the deflection applied by the programmable deflection plane to each individual beam incident on the programmable deflection plane. Thus, programmable deflection planes are used in optical switches as a controllable switching element. The programmable deflection plane may be implemented by an LCOS, MEMS device, digital micromirror device (DMD) or a liquid crystal layer that can control the deflection of a beam incident on or through it.

The optically active areas may be programmable attenuation planes. A programmable attenuation plane applies a controllable attenuation to different positions on the programmable attenuation plane. The attenuation is applied to all channels simultaneously. Programmable attenuation planes may utilise polarisation to achieve the attenuation.

For an optical arrangement having two optically active areas, both optically active areas may be programmable deflection planes. Alternatively, one optically active area may be a programmable deflection plane and the other optically active area a programmable attenuation plane.

For an optical arrangement having three optically active areas, all three optically active areas may be programmable deflection planes. Alternatively, two optically active areas may be programmable deflection planes and one optically active area a programmable attenuation plane.

Generally, the optically active areas of an optical arrangement may be implemented by any combination of programmable deflection planes and programmable attenuation planes.

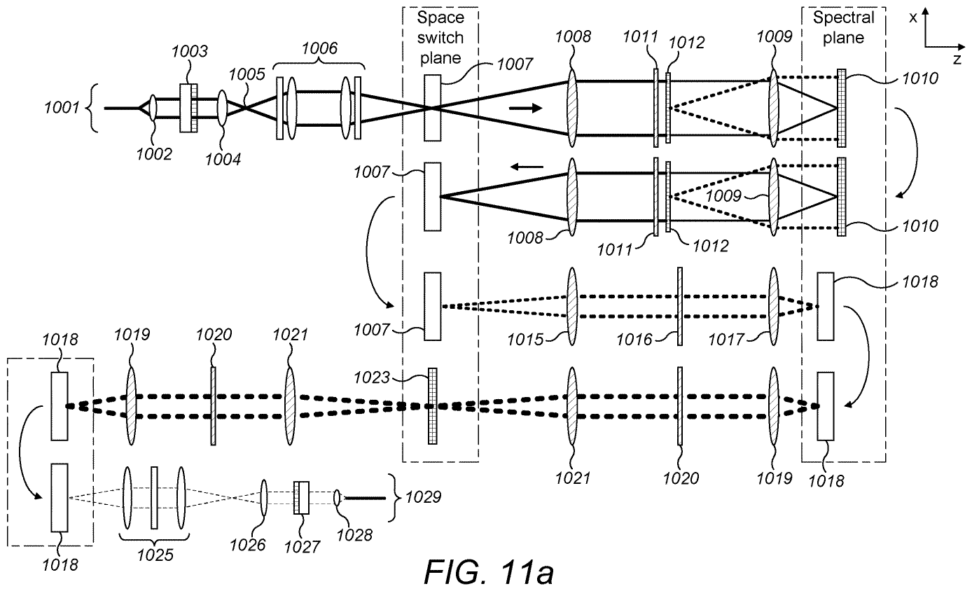

The size of the two or more optically active areas of the optical arrangement may be different. FIG. 9 illustrates an example in which a first optically active area 901 has a different dimension (for example height) to a second optically active area 902. This may be the case, for example, with two programmable deflection planes, in which the first programmable deflection plane comprises space switches and the second programmable deflection plane comprises spectra. Spectra use a higher area of SLM plane than space switches.

The left-hand image of FIG. 9 illustrates the SLM as viewed from above. The middle image of FIG. 9 illustrates an oblique view of the arrangement. The right-hand image of FIG. 9 illustrates a side-on view of the arrangement.

A 45° reflector overlaying the smaller optically active area naturally would have a reflecting surface located closer to the plane of the optically active area than a 45° reflector overlaying the larger optically active area. However, this would cause the centre of reflection of each of the reflectors to be at different distances from the plane of the optically active areas. This would be problematic in an implementation in which a single optical layout with a coplanar optical axis is used. FIG. 9 illustrates an arrangement in which the reflector 903 overlaying the smaller optically active area 901 is raised relative to the plane of the optically active areas 901 and 902 such that the centre line 905 of the reflecting surfaces of both reflectors 903 and 904 are in the same plane as each other and the same plane as the optical axis.

The intention of FIG. 9 is to arrange the reflectors such that the centre lines of the reflecting surfaces of the reflectors are in the same plane as each other. However, in some optical systems the optical axis of the first optical signal incident on the first reflector may be at a different height relative to the SLM plane to the optical axis of the second optical signal incident on the second reflector. In such optical systems, each reflector is sized such that the centre line of the reflecting surface of the reflector is in the plane of the optical axis of the optical signal incident on the reflector. Thus, the centre lines of the reflecting surfaces of the reflectors are in different planes to each other.

The optical arrangements described herein may be used in an optical switch. For example, they may be utilised in WSS systems.

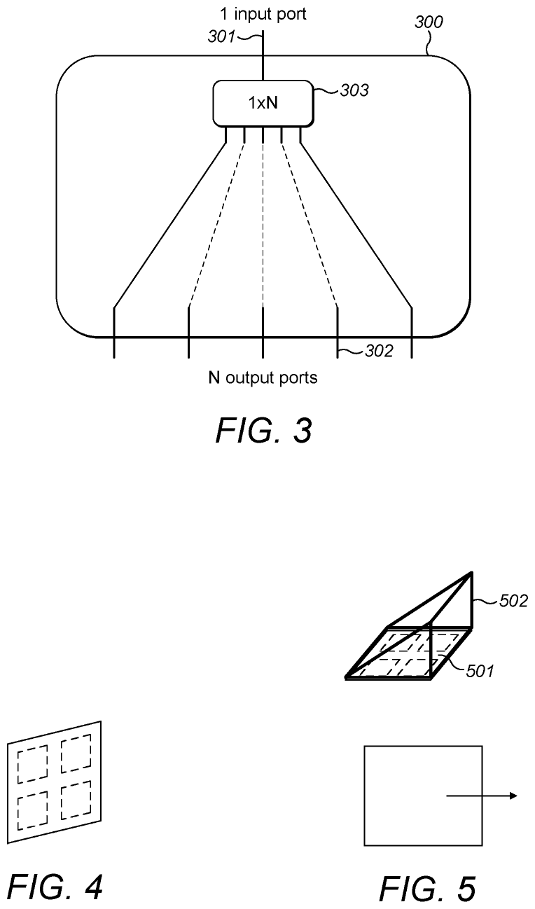

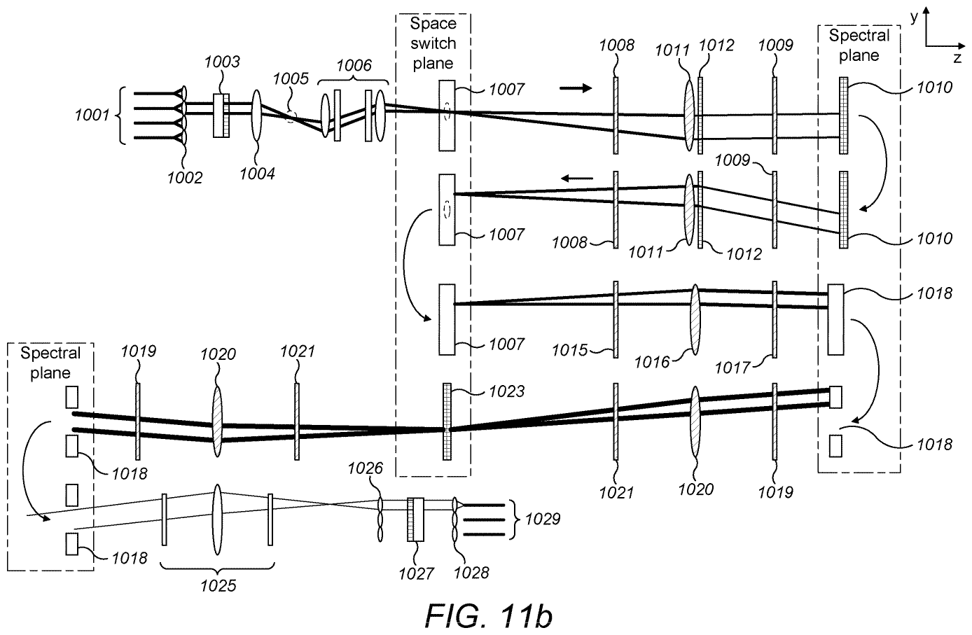

FIG. 10 illustrates a two-plane WSS utilising the configuration of add/drop ports shown in FIG. 2. The WSS has the optical arrangement shown in FIG. 6a. Thus, FIG. 10 utilises a single SLM having two optically active areas, each overlaid with a reflector. The second optically active area is a set of space switches. The SLM is laid flat in the dispersion-switching plane, parallel to the plane of the optical axis. The two reflectors are opposing and redirect optical signals received from opposing directions in the plane of the optical axis down onto the SLM. The WSS is an add-drop WSS which has N input ports and M output ports, where N<<M. Each of the input and outport ports transports an optical signal having at least one component frequency channel. Beam steering optics are used to direct the optical signals from the input ports to the first optically active area of the SLM, and to direct the optical signals from the first optically active area of the SLM to the second optically active area of the SLM, and to direct the optical signals from the second optically active area of the SLM to the output ports.

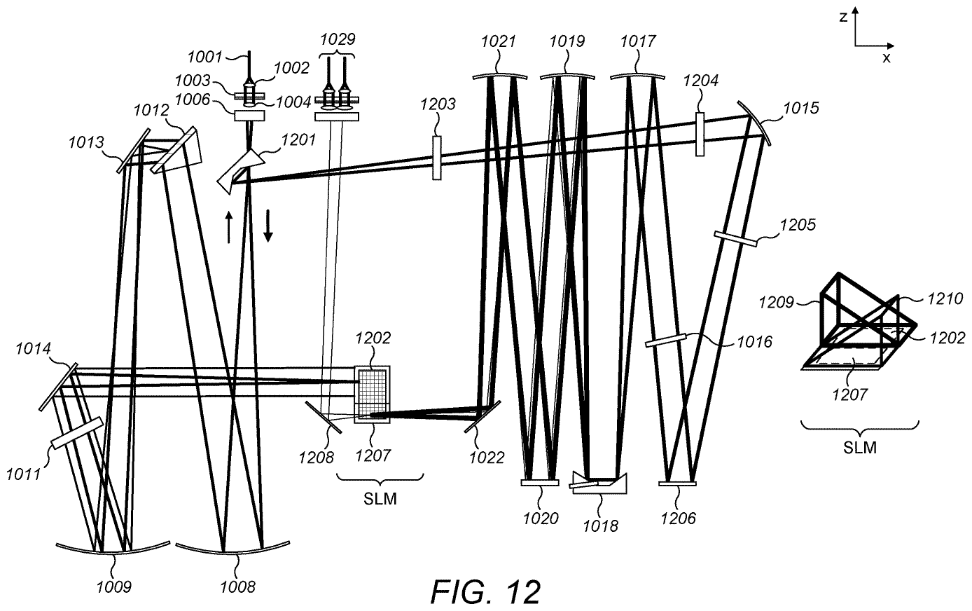

FIGS. 11a and 11b illustrate the detailed optical path of light as it is routed through the components of the WSS of FIG. 10. FIG. 11a illustrates the optical path in the dispersion plane, i.e. the x axis shown is the dispersion axis and the z axis is the optical axis. FIG. 11b illustrates the path in the switching plane, i.e. the y axis shown is the switching axis and the z axis is the optical axis. Thus, FIG. 11b illustrates an orthogonal plane to FIG. 11a. FIGS. 11a and 11b illustrate a sequential layout of the optical path. Elements shown multiple times may be the same optical element. The optical elements may be ordered in a different sequence to that shown in FIGS. 11a and 11b. Some flat mirrors used only for directing the optical axis in FIG. 10 (e.g. 1022 and 1024) are not shown in FIG. 11a and b as they do not affect the operation of the system. Further flat mirror or prism elements may be incorporated into the system of FIG. 10 to make the system more compact.

The switch of FIG. 10 comprises N input ports 1001. The optical signals from the input ports are collimated by an array of coupling lenses 1002 and from there pass through polarisation diversity optics 1003. The optical signals are then imaged by a single fan lens 1004 to a single circular focus 1005. The optical signals then pass through an anamorphic telescope 1006 which converts the beam shapes from circular to elongated. The elongated beams have the desired waist ratio in the switching and dispersion directions. The anamorphic telescope 1006 comprises two cylindrical elements with optical power in a 4F relationship for each of the dispersion and switching planes. A separate fan lens 1004 is used to distribute power from the input ports 1001. The optical signals then pass through a hole in mirror 1007. The anamorphic telescope 1006 focuses the optical signals to an anamorphic focus at the hole in the mirror 1007.

The optical signals are then imaged through a pair of cylindrical mirrors 1008 and 1009 with power in the dispersion direction onto the first optically active area 1010 of an SLM via the reflector of the optical arrangement of FIG. 6a. The sub diagram on the right-hand side of FIG. 10 illustrates the reflector 1030 which directs light to optically active area 1010, and the reflector 1031 which directs light to optically active area 1023. Between the two cylindrical mirrors 1008 and 1009 is a cylindrical lens 1011 which has power in the switching axis and a grism 1012 (diffraction grating and prism). The cylindrical lens 1011 may be at the Fourier plane between mirrors 1008 and 1009. If cylindrical lens 1011 is not at the Fourier plane between mirrors 1008 and 1009 then a telecentric corrector may be used at the mirror plane 1007. The grism is at the Fourier plane between mirrors 1008 and 1009. The grism disperses the optical signal from each of the N ports into a frequency spectrum. The N spectra are imaged onto the first optically active area 1010 of the SLM plane via first reflector 1030. Flat mirror 1013 between the grism 1012 and cylindrical mirror 1009, and flat mirror 1014 between the cylindrical mirror 1009 and SLM are used to redirect the optical signals within the optical switch.

The first optically active area 1010 of the SLM is a programmable deflection plane. It deflects light in the switching direction, which then propagates back through the first reflector, cylindrical mirror 1009, grism 1012, and cylindrical mirror 1008 to mirror 1007. An array of spots relating to the required output ports are imaged on mirror 1007 away from the hole. Mirror 1007 reflects the optical signals to a lens triple comprising two cylindrical mirrors 1015 and 1017 with power in the dispersion axis in a 4F arrangement, and a switching lens 1016 at the Fourier plane between the two mirrors 1015 and 1017. The switching lens 1016 may be replaced with a single lens of the same power with a deflecting flat mirror. This would achieve the almost 90° change of direction of the optical path, with a better optical performance and fewer introduced aberrations. The optical signals propagate from the cylindrical mirror 1017 to a gap optic 1018. The gap optic allows propagation of some signals through it unimpeded. However, the optical signals incident on it from the cylindrical mirror do not pass through the gap optic. These optical signals are deflected by the gap optic 1018 to a further lens triple comprising two cylindrical mirrors 1019 and 1021 with power in the dispersion axis in a 4F arrangement, and a switching lens 1020 at the Fourier plane between the two mirrors 1019 and 1021.

From mirror 1021, the optical signals are deflected by flat mirror 1022 onto the second reflector of the optical arrangement of FIG. 6a, and from there to the second optically active area 1023 of the SLM. The direction of the optical signals approaching the second reflector 1031 opposes that of the direction of the optical signals approaching the first reflector. The second optically active area 1023 is a programmable deflection plane. The optical signals output from the second optically active area propagate back through reflector 1031 to the lens triple 1021, 1020 and 1019 to the gap optic 1018. This, time, the optical signals travel through the gap optic unimpeded towards the M output ports.

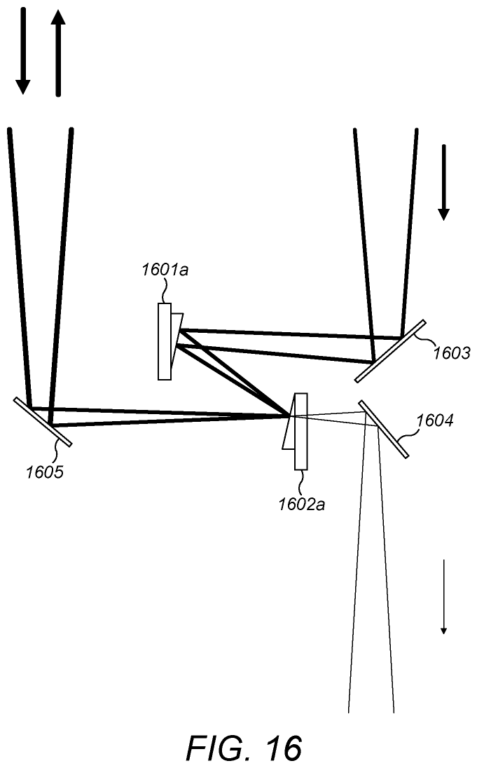

The gap optic 1018 may be implemented as a mirror with an aperture in it. FIG. 16 illustrates another implementation of a gap optic 1018. In this implementation, a mirror array comprises a first array of mirror surfaces 1601a and a second array of mirror surfaces 1602a. The mirror array comprises pairs of parallel mirror surfaces. The mirror surface 1601a of the first array of mirror surfaces is parallel to the mirror surface 1602a of the second array of mirror surfaces. The array further includes three flat directing mirrors 1603, 1604 and 1605. The light first passes through the gap optic by being directed from mirror 1603 onto mirror surface 1601a, and from there to mirror surface 1602a, and from there is reflected via mirror 1605 towards the SLM plane. On return of the light from the SLM plane, it is reflected from mirror 1605 onto mirror surface 1602a. This time it passes through mirror surface 1602a to mirror 1604 which reflects the light onto the optical path that eventually leads to the output ports.

The optical signals are redirected by flat mirror 1024 from the gap optic 1018 to an anamorphic telescope 1025 which changes the beam shape back to circular. If the number of output ports is much larger than the number of input ports, then the anamorphic telescope 1025 may comprise two 4F elements with the dispersion plane power only and a single lens with the switching power. The optical signals then pass through an optional microlens array 1026 and polarisation diversity optics 1027. The optical signals are then collimated by a coupling lens 1028 to the M output ports 1029.

Thus, the switch of FIG. 10 utilises the arrangement of FIG. 6a in which optical signals approach the SLM from two opposing directions to enable a more compact design for the switch with two optic planes on either side of the SLM. The SLM is accessed sequentially, first via the first optically active area and then via the second optically active area. The optical signals incident on both optically active areas are the same, albeit having propagated through the optics described in between the optically active areas.

The WSS of FIG. 10 May Be Implemented in a ROADM Arrangement.

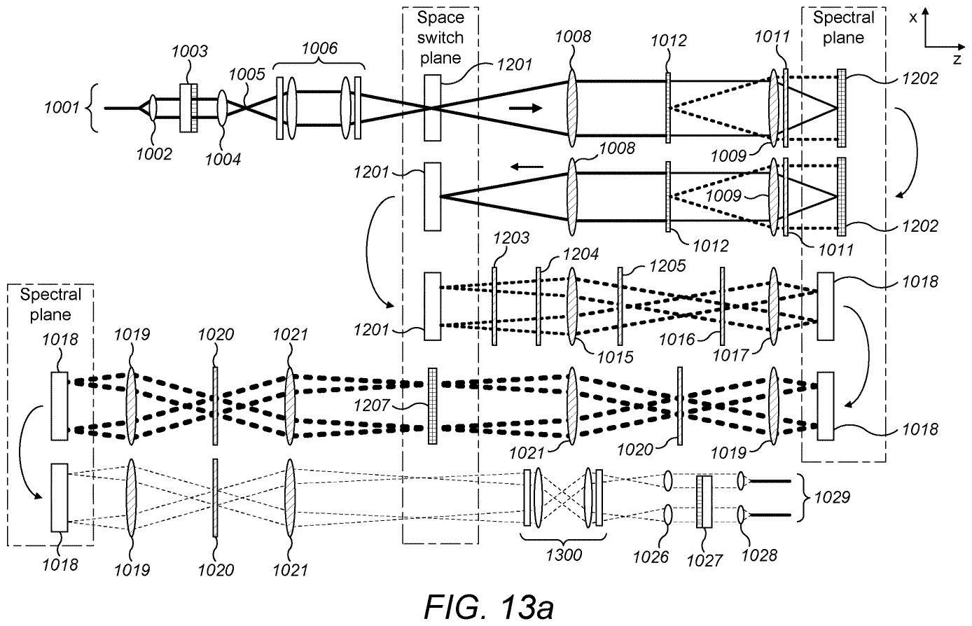

FIG. 12 illustrates a two-plane add-drop WSS. The switch may comprise two SLMs placed together flat in the dispersion-switching plane, parallel to the plane of the optical axis. The SLMs have two optically active areas, each overlaid with a reflector. The reflectors are opposing and redirect optical signals received from opposing directions in the plane of the optical axis down onto the SLMs. Both reflectors access both SLMs. One of the reflectors is a polarising beam splitter, as will be described in more detail below.

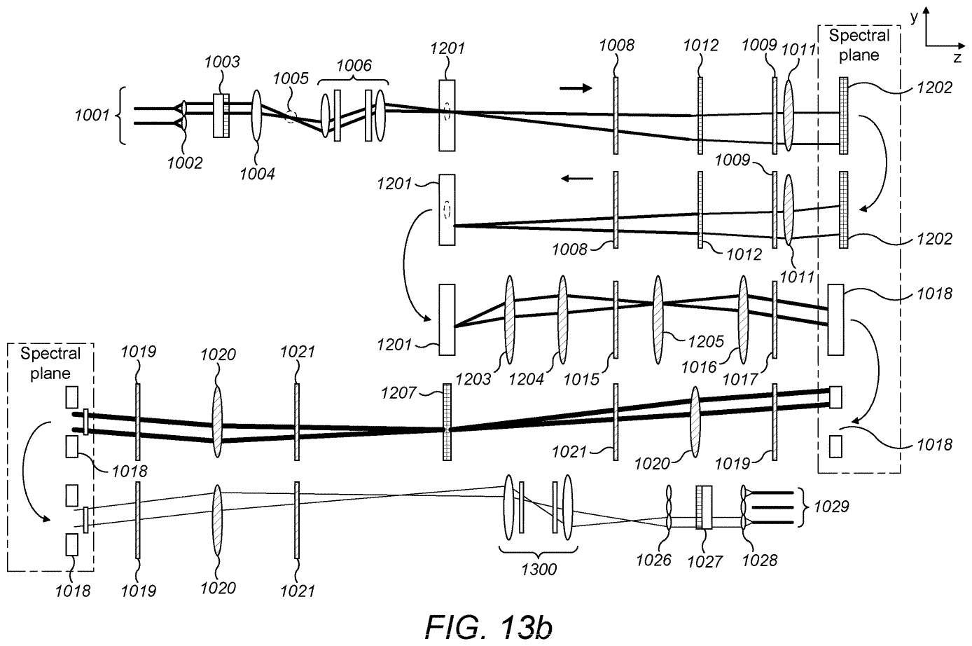

FIGS. 13a and 13b illustrate the detailed optical path of light as it is routed through the components of the WSS of FIG. 12. FIG. 13a illustrates the optical path in the dispersion plane, i.e. the x axis shown is the dispersion axis and the z axis is the optical axis. FIG. 13b illustrates the path in the switching plane, i.e. the y axis shown is the switching axis and the z axis is the optical axis. Thus, FIG. 13b illustrates an orthogonal plane to FIG. 13a. FIGS. 13a and 13b illustrate a sequential layout of the optical path. Elements shown multiple times may be the same optical element. The optical elements may be ordered in a different sequence to that shown in FIGS. 13a and 13b.

The switch of FIG. 12 shares many features in common with that of FIG. 10. Those features that are the same are depicted with the same reference numerals. As described with respect to FIG. 10, the switch of FIG. 12 comprises N input ports 1001. Optical signals from the input ports propagate through coupling lenses 1002, polarisation diversity optics 1003, fan lens 1004 and anamorphic telescope 1006 as described for FIG. 10. The anamorphic focus point is at remapping optic 1201, which will be described later. The optical signals pass directly through the remapping optic 1201 at this stage.

The optical signals then pass through the same cylindrical mirror 1008, grism 1012, cylindrical mirror 1009 and cylindrical lens 1011 onto the first optically active area 1202 of an SLM via the reflector 1209 overlaying the first optically active area 1202 of the SLM device. The sub diagram on the right-hand side of FIG. 12 illustrates the reflector 1209 which directs light to optically active area 1202, and the reflector 1210 which directs light to optically active area 1207. As with FIG. 10, flat mirrors 1013 and 1014 are used to redirect the optical signals within the optical switch. The only difference with FIG. 10 is that the switching cylindrical lens 1011 is not collocated with the grism 1012. The telecentric corrector lens 1205 and 4F imaging system 1203/1204 described below are a consequence of this. Instead, the switching cylindrical lens 1011 is located between the cylindrical mirror 1009 and the first optically active area 1010.

The first optically active area 1202 of the SLM device is a programmable deflection plane. It deflects light in the switching direction, which then propagates back through the first reflector, switching lens 1011, cylindrical mirror 1009, grism 1012, and cylindrical mirror 1008 to remapping optic 1201.

The remapping optic 1201 independently controls the spatial positioning and/or orientation of each beam from the deflected array of beams from the programmable deflection plane 1202 to a remapped array of beams. In this way, it changes the spatial positioning and/or orientation of at least one beam of the deflected array of beams differently to at least one other beam of the deflected array of beams. The remapping optic may be a mirror, mirror array, freeform optic or a retroreflecting prism. For example, the remapping optic may be a prism structure and/or a mirror structure which has multiple sections, each of which provides a light path for a different portion of the spectra from the programmable deflection plane 1202. Those light paths are different, and hence result in a redistribution of the portions of the spectra output from the remapping optic. Specifically, those spectral portions are arranged differently in position and/or orientation to the spectral portions input to the remapping optic 1201.

From the remapping optic 1201, the optical signals propagate through a 4F system comprising cylindrical lenses 1203 and 1204 which have power only in the switching axis, which form an image on a telecentric corrector lens 1205. The telecentric corrector lens 1205 is a cylindrical lens with power only in the switching axis. Between the cylindrical lenses 1203 and 1204 and the telecentric corrector lens 1205 is cylindrical mirror 1015 with power in the dispersion axis. Instead, cylindrical mirror 1015 may be replaced with a flat mirror and a lens. The optical signals are then directed by flat mirror 1206 onto cylindrical mirror 1017 via cylindrical lens 1016 which has power only in the switching axis.

The optical signals propagate from the cylindrical mirror 1017 to the second reflector overlaying the second optically active area 1207 of the SLM device via the same optical structures as described with respect to FIG. 10. Thus, the optical signals propagate to the second reflector via gap optic 1018, cylindrical mirrors 1019, 1020 and 1021, and flat mirror 1022.

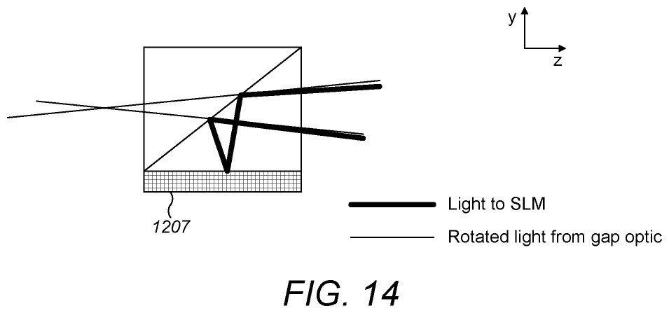

The second reflector is a polarising beam splitter 1210. The polarising beam splitter is shown in detail in FIG. 14. The optical signals which first reach the polarising beam splitter are reflected by the polarising beam splitter onto the second optically active area 1207 of the SLM. The second optically active area is a programmable deflection plane.

The optical signal output from the second optically active area 1207 propagates back through the lens triple 1021, 1020 and 1019 to the gap optic 1018. The gap optic 1018 of FIG. 12 is different to that of FIG. 10. The gap optic of FIG. 12 may be implemented using a mirror and a quarter waveplate. The optical signals which propagated initially past the gap optic to the second optically active area 1207 are polarised in one direction due to the polarisation diversity optics 1003 near the input ports at the entrance to the switch. If the SLM which houses the second optically active area 1207 is an LCOS device, then it will only operate on one polarisation. The optical signals are polarised to match the operable polarisation of the SLM. When the optical signals output from the second optically active area 1207 reach the gap optic 1018, they are incident on the “gap” which is a quarter waveplate and flat mirror. The optical signals pass through the quarter waveplate and are then reflected by the mirror back through the quarter waveplate. The resulting optical signals output from the gap optic have their polarisation rotated by 90°.

The optical signals are reflected from the gap optic 1018 back through the lens triple 1019, 1020 and 1021 via flat mirror 1022 to the second reflector overlaying the second optically active area 1207. Due to the rotated polarisation of the optical signals, this time the polarising beam splitter transmits the optical signals straight through the polarising beam splitter towards the output ports.

From the output of the polarising beam splitter, the optical signals are redirected by flat mirror 1208 to an anamorphic telescope 1300 which changes the beam shape back to circular. The optical signals may then pass through microlens array 1026 and polarisation diversity optics 1027. The optical signals are then collimated by a coupling lens 1028 to the M output ports 1029.

The switch of FIG. 12 has the benefits of the switch of FIG. 10. Additionally, use of the polarising beam splitter minimises the optics needed for outcoupling light to the output ports. The optical path passes through the components from the gap optic to the polarising beam splitter three times, thereby reducing the component count in the switch and reducing tolerance fabrication issues and layout size.

The WSS of FIG. 12 may be implemented in a ROADM arrangement.

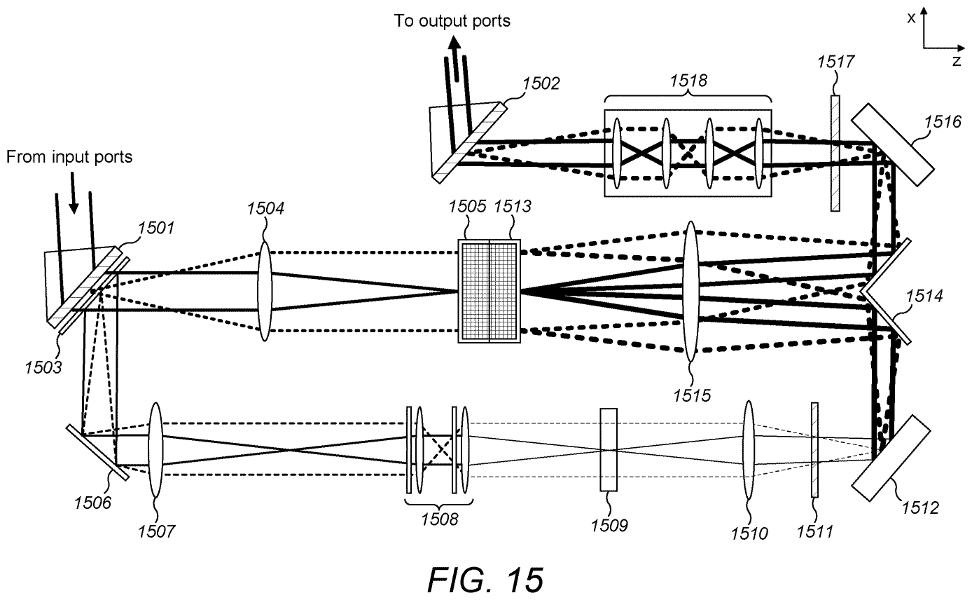

FIG. 15 illustrates a further exemplary optical switch which utilises the optical arrangement of FIG. 9. The switch of FIG. 15 is a one plane system, where two interactions with the SLM plane are used. As will be described below, the second optically active area of the SLM plane is used to control crosstalk and channel attenuation. The switch may be a filtered 1×N arrangement.

The switch comprises an SLM laid flat in the dispersion-switching plane, parallel to the plane of the optical axis. The SLM has two optically active areas, each overlaid with a reflector. The reflectors are opposing and redirect optical signals received from opposing directions in the plane of the optical axis down onto the optically active areas of the SLM.

FIG. 15 illustrates the dispersion plane, i.e the x axis shown is the dispersion axis and the z axis shown is the optical axis. The optical layout to achieve the routing of the optical beams from the input ports to the demultiplexer 1501 is not shown. This may be achieved by any known set of optics. Similarly, the optical layout to achieve the routing of the optical beams from the multiplexer 1502 to the output ports is not shown. This may be achieved by any known set of optics as long as the gap optic 1503 plane is a conjugate Fourier transform of the LCOS plane in the switching axis.

Light from the input ports is demultiplexed at grism 1501. The light is then imaged via 4F lens 1504 onto a first reflector overlaying a first optically active area 1505 of the SLM. This first optically active area 1505 may be a programmable deflection plane. The light is directed by the first reflector onto the programmable deflection plane 1505 where it is deflected back through the first reflector, through the 4F lens 1504 onto gap optic 1503. The gap optic 1503 may be a mirror with an aperture in it as described above. The light is reflected by the gap optic 1503, and a further mirror 1506, then through lens 1507 to anamorphic converter 1508. The anamorphic converter 1508 converts the light beam shape from an elongated beam shape back to a circular shape.

Light beams output from the anamorphic converter 1508 pass through space optic 1509 which increases the space between the spectra without magnifying the beams. For example, the space optic 1509 may be implemented using a linear prism array located in the spectral plane. The linear prism array may comprise a pair of parallel refractive surfaces for each spectrum and different and increasing angle to the normal to the dispersion plane. The light beam reaching the first of the pair of surfaces refracts away from the centre and is re-collimated by the second of the pair of surfaces. The spacing between light beams output from the linear prism array is greater than those input to the linear prism array. However, the individual light beams themselves are not magnified. The beam size of each remains the same.

The light then passes through 4F lens 1510, then polarisation element 1511 to optic 1512. The 4F lenses 1507 and 1510 together are in a 4F arrangement to image the output ports from the gap optic 1503 to the optic 1512. Although shown as lenses 1507 and 1510, the same optical path may be achieved through use of other optical components, such as mirrors. Polarisation element 1511 may comprise a half waveplate at 22.5°. The polarisation element 1511 rotates the polarisation of the incident light beams by 45°. This has the effect of causing the LCOS to act as a polarisation rotator (for the subsequent programmable attenuation plane) rather than as a hologram (for the previous programmable deflection plane).

Optic 1512 splits each component frequency channel of the beams input to it into the number of unique positions to be imaged on the second optically active area 1513. For example, the optic 1512 may be a wedge mirror which splits each component frequency channel of each beam input to it into two, so as to cause two images on the subsequent second optically active area 1513 at unique positions. These two images may correspond to a wanted upper port spot and an unwanted lower port spot.

Following the optic 1512, the light beams are directed via mirror array 1514 through a conjugate lens 1515 to the second reflector overlaying the second optically active area 1513. The second reflector directs the light beams onto the second optically active area 1513. The second optically active area 1513 is implemented as a programmable attenuation plane. Conjugate lens 1515 forms a Fourier conjugate image of the optical plane of optic 1512 on the programmable attenuation plane. Thus, the spectral plane is imaged onto the programmable attenuation plane.

After attenuation at the programmable attenuation plane, the light beams pass back through the second reflector, the conjugate lens 1515 and are directed by mirror array 1514 onto optic 1516. Optic 1516 applies the inverse of optic 1512. Thus, in the case that optic 1512 is a wedge mirror, optic 1516 is an inverse wedge mirror. The light beams then propagate to polarisation selection element 1517, which may be a 45°sample polariser.

From the polarisation selection element 1517, the light beams pass through inverter 1518 which orientates the spectra for subsequent multiplexing at grism 1502, following which the light beams are transmitted to the output ports. The inverter 1518 is used if the output grism 1502 is the same as the input grism 1501. However, the inverter 1518 may be omitted if the output grism 1502 is different to the input grism 1501, and in particular if the output grism 1502 has the opposite diffraction order to the input grism 1501.

FIG. 15 illustrates a single LCOS panel which comprises two areas, one for the programmable deflection plane 1505 and one for the programmable attenuation plane 1513. The LCOS panel is positioned flat parallel to the dispersion plane. Although FIG. 15 illustrates a single LCOS panel, two separate SLMs could instead be used. However, using the same SLM panel for both the programmable deflection plane and the programmable attenuation plane optimises area utilisation on the SLM panel since the area used for the attenuation is significantly less than the area used for the deflection.

Since the SLM area used for the attenuation plane is significantly less than the SLM area used for the deflection plane, the first and second reflectors may implement the arrangement shown in FIG. 9. In other words, the second reflector overlaying the attenuation plane may be raised such that the centre of the reflecting area of the second reflector, the centre of the reflecting area of the first reflector, and the optical axis of the optical system are all in the same plane.

The programmable attenuation plane 1513 retards one axis of the incident attenuation spot, which is subsequently attenuated by the polarisation selection element 1517. Instead, an LCOS deflection scheme or MEMS with a beam stop may be used.

Although gap optic 1503 is depicted in FIG. 15, it may be omitted. For example, in the case that the SLM panel housing the programmable deflection plane is not illuminated normally, the deflection from the SLM panel follows a different path away from the demultiplexer 1501. In this scenario, the gap optic 1503 is not required to prevent the deflected light from the programmable deflection plane from falling incident on the demultiplexer.

Although space optic 1509 is depicted in FIG. 15, it may be omitted. For example, if there is only one spectrum, then the space optic is not required. As another example, if there is sufficient space between the spectral images in the spectral plane on the programmable deflection plane such that the number of required unique spots on the programmable attenuation plane for each spectral beam can be formed without overlapping each other, then the space optic is not required. However, allowing sufficient space on the programmable deflection plane comes at the cost of not efficiently using the LCOS SLM area.

Although optic 1516 is depicted in FIG. 15, it may be omitted. For example, the output port positions and/or optics between the programmable attenuation plane and the output ports may be modified to accommodate the range of angles observed at the output port plane.

The above described exemplary switches utilise two optically active areas on the SLM planes. An example of a switch that requires three or four optically active areas, with the optical signals incident on the reflectors associated with each optically active area coming from different directions, are two plane architectures where there is a filtering layer in one or both planes.

Positioning the optical components of a system that accesses an SLM device twice sequentially from the same direction is challenging from a layout perspective. The examples described herein enable two separate optical systems, such as a multiplexer/demultiplexer system and an add/drop system, to lie separately on different sides of a single LCOS. This allows the LCOS to operate as two planes whilst still maintaining the design freedom to choose the optical elements as would be available with two separate planes. Thus, the examples described herein allow improved optical layout control for more than one interaction with a single SLM. They also reduce the size of the layout. With better control of the layout, improved efficiency and latency can be achieved.

The examples described herein have optical components in a sequential order in optical switches. However, it will be understood that the same optical effect may be achieved by modifying the sequential layout of some of the optical components. Thus, the optical components within each switch may be in a different order in the optical path to those shown and described.

In the examples described herein, optical components are used to route data through the described switches. There is no absorption and re-emission of light, thereby avoiding the lag associated with transmitting data through electronical switches. The optical components also have lower power consumption than equivalent electronical implementations.

The example switches described herein incorporate a diffraction grating or grism. However, any demultiplexer which demultiplexes light signals into spatially separated data channels may be used instead of a diffraction grating in any of the examples. Similarly, any multiplexer which multiplexes spatially separated data channels into multiplexed light signals may be used instead of a diffraction grating in any of the examples. Any suitable optical dispersion device may be used as a multiplexer and/or a demultiplexer.

Lenses and other optical components described herein as single structures may be implemented using assemblies having a plurality of components which achieve the same optical effect. Examples of such assemblies are: achromatic doublets, achromatic triplets, Cook doublets, telescopes and microscopes for imaging lenses. The lenses described herein may be implemented using other optics with the same optical power. For example, a curved mirror may be used as a lens. For example, multiple lens elements, mirrors, mirror arrays, catadioptric systems, holographic optical elements or diffractive optical elements may be used as a lens. Separate elements, for example 4F lenses, with the same optical properties can be arranged as separate passes through or from a single physical element. Cylindrical mirrors may be replaced by a lens and a flat mirror.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An optical system comprising:
a first spatial light modulator plane having a first optically active area configured to receive a first optical signal from the optical system;
a second spatial light modulator plane having a second optically active area configured to receive a second optical signal from the optical system;
a first reflector overlaying the first optically active area at an angle to the first optically active area so as to direct the first optical signal approaching the first reflector from a first direction onto the first optically active area; and
a second reflector overlaying the second optically active area at an angle to the second optically active area so as to direct the second optical signal approaching the second reflector from a second direction onto the second optically active area, wherein the second direction is different to the first direction.

2. An optical system as claimed in claim 1, wherein the first optically active area is coplanar with the second optically active area.

3. An optical system as claimed in claim 1,, wherein the first and second spatial light modulator planes are parallel to the optical axis plane of the optical system.

4. An optical system as claimed in claim 1, wherein a single spatial light modulator device comprises the first and second spatial light modulator planes.

5. An optical system as claimed in claim 1, wherein the incidence normal of the first spatial light modulator plane is within the same hemispherical angular area as the incidence normal of the second spatial light modulator plane.

6. An optical system as claimed in claim 1, wherein:
the first reflector comprises a 45° reflecting surface configured to turn the first optical signal incident on it by 90° so as to direct the first optical signal normal to the plane of the first optically active area; and
the second reflector comprises a 45° reflecting surface configured to turn the second optical signal incident on it by 90° so as to direct the second optical signal normal to the plane of the second optically active area.

7. An optical system as claimed in claim 1, wherein the centre of the reflecting area of the first reflector, the centre of the reflecting area of the second reflector, and the optical axis of the optical system are all in the same plane.

8. An optical system as claimed in claim 1, wherein the first direction opposes the second direction.

9. An optical system as claimed in claim 1, wherein the first direction is perpendicular to the second direction.

10. An optical system as claimed in claim 1, wherein the first reflector and/or second reflector are mirrors.

11-13. (canceled)

14. An optical system as claimed in claim 1, wherein the first reflector and/or second reflector comprises a half wave plate.

15. An optical system as claimed in claim 1, wherein the first optically active area is a programmable deflection plane and the second optically active area is a programmable deflection plane.

16. (canceled)

17. An optical system as claimed in claim 1, wherein the second optically active area is a programmable attenuation plane.

18. An optical system as claimed in claim 1, wherein the first reflector overlays the first optically active area at an angle to the first optically active area so as to direct the first optical signal normal to the plane of the first optically active area and the second reflector overlays the second optically active area at an angle to the second optically active area so as to direct the second optical signal normal to the plane of the second optically active area.

19. (canceled)

20. An optical system as claimed in claim 1, wherein the first optical signal is the same as the second optical signal.

21. An optical system as claimed in claim 1, wherein the optical system is an optical switch comprising:
a set of input ports, each input port configured to transport the first optical signal having at least one component frequency channel;
a set of output ports, each output port configured to transport the second optical signal having at least one component frequency channel; and
beam steering optics configured to direct the first optical signal in the first direction to the first reflector, and configured to direct the second optical signal in the second direction to the second reflector.

22. An optical system as claimed in claim 1, further comprising:
a third spatial light modulator plane having a third optically active area configured to receive a third optical signal from the optical system; and
a third reflector overlaying the third optically active area at an angle to the third optically active area so as to direct the third optical signal approaching the third reflector from a third direction onto the third optically active area.

23. An optical system as claimed in claim 22, wherein the third optically active area is a programmable deflection plane.

24. An optical system as claimed in claim 22, wherein the first, second and third directions are all different.

25. An optical system as claimed in claim 22, wherein the first and third directions are the same.
